(19) United States
(12) Patent Application Publication
(10) Pub. No.: US 2016/0212626 A1
(43) Pub. Date: Jul. 21, 2016

(54) NEXT GENERATION BROADCAST PLATFORM RADIO FRAME EXTENSIBILITY BROADCAST/UNICAST TDD IN INTELLIGENT HETEROGENEOUS NETWORKS

(71) Applicant: SINCLAIR BROADCAST GROUP, INC., Hunt Valley, MD (US)

(72) Inventors: Michael J. SIMON, Frederick, MD (US); Mark A. AITKEN, Parkton, MD (US)

(21) Appl. No.: 15/001,014

(22) Filed: Jan. 19, 2016

Related U.S. Application Data
(60) Provisional application No. 62/104,906, filed on Jan. 19, 2015.

(51) Int. Cl. H04W 16/14

(52) U.S. Cl. CPC H04W 16/14

(57) ABSTRACT

A method for operating an extensible mode of communication in an intelligent heterogeneous network includes the step of using an extensibility tool to provide an extensible framing structure. The method further includes the step of combining a centralized radio access network topology with an intelligent IP core network to enable sharing of spectrum resources. The method further includes the step of providing a supplemental return channel to facilitate paging.

### CROSS-REFERENCE TO RELATED APPLICATIONS

This application claims priority from U.S. Patent Application No. 62/104,906 filed on Jan. 19, 2015, which is incorporated by reference herein in its entirety.

### FIELD OF DISCLOSURE

The present disclosure relates to the field of wireless communication, and more particularly, to next generation broadcast platform radio frame broadcast/unicast TDD in intelligent heterogeneous wireless networks.

### BACKGROUND

A key part of the FCC's efforts to meet increasing demand for spectrum is the first-of-its-kind Incentive Auction, a means of repurposing spectrum by encouraging licensees to voluntarily relinquish spectrum usage rights in exchange for a share of the proceeds from an auction of new licenses to use the repurposed spectrum.

Initially described in the 2010 National Broadband Plan and authorized by Congress in 2012, the auction will use market forces to align the use of broadcast spectrum with 21^{st} century consumer demands for video and broadband services. It will preserve a robust broadcast TV industry while enabling stations to generate additional revenues that they can invest into programming and services to the communities they serve. By making valuable “low-band” airwaves available for wireless broadband, the incentive auction will benefit consumers by easing congestion on wireless networks, laying the groundwork for “fifth generation” (5G) wireless services and applications, and spurring job creation and economic growth.

Thus, to preserve a robust broadcast TV industry, it may be desirable for Broadcasters to start planning for efficient use of spectrum in the FCC re-pack and new business models to remain competitive. In particular, Broadcasters may desire to identify flexible and scalable broadcast modes and duplex schemes to enable both hyperlocal targeted and mass multimedia services over larger geographic areas through dynamic network topologies exploiting programmable (NFV/SDN) radio functions that can be activated, deactivated, and modified on demand depending on the specific needs of the service and in response to consumer demand using both licensed and unlicensed spectrum inside and outside the broadcast band.

Technical contributions to the emerging ATSC 3.0 standard, which is based on a new OFDM physical layer and IP as transport and an extensible OFDM framework, are continuously being made. However, this emerging ATSC 3.0 standard is constrained to target traditional services such as 4K UHDTV as efficient use of spectrum.

While personalization of communication will lead to a reduced demand for legacy broadcast as deployed today, e.g. linear TV, the fully mobile and connected society will nonetheless need efficient distribution of information from one source to many destinations. These services may distribute content as done today (typically only downlink), but also provide a feedback channel (uplink) for interactive services or acknowledgement information. Several broadcast-like use cases may be proposed for future 5G networks.

News and Information—Beyond 2020, receiving text/pictures, audio and video, everywhere and as soon as things happen (e.g., action or score in a football match) will be common. Customers in specific areas should simultaneously receive appropriate news and information regardless of the device they are using and their network connection.

Local Broadcast-Like Services—Local services will be active at a cell level with a reach of, for example, 1 to 20 km. Typical scenarios include stadium services, advertisements, voucher delivery, festivals, fairs, and congress/convention. Local emergency services can exploit such capabilities to search for missing people or in the prevention or response to crime (e.g. theft).

Regional Broadcast-Like Services—Broadcast-like services with a regional reach will be required, for example, within 1 to 100 km. A typical scenario includes communication of traffic jam information. Regional emergency warnings can include disaster warnings. Unlike the legacy broadcast service, the feedback channel can be used to track delivery of the warning message to all or selected parties.

National Broadcast-Like Services—National or even continental/world-reach services are interesting as a substitute or complementary to broadcast services for radio or television. Also vertical industries will benefit from national broadcast-like services to upgrade/distribution of firmware. The automotive industry may leverage the acknowledgement broadcast capability to mitigate the need for recall campaigns. This requires software patches to be delivered in large scale and successful updates to be confirmed and documented via the feedback channel.

Thus, improvements to existing networks may be contemplated.

### SUMMARY

A method for operating an extensible mode of communication in an intelligent heterogeneous network includes the step of using an extensibility tool to provide an extensible framing structure. The method further includes the step of combining a centralized radio access network topology with an intelligent IP core network to enable sharing of spectrum resources. The method further includes the step of providing a supplemental return channel to facilitate paging.

In one example, the extensible mode of communication includes time-division duplexing, including broadcast and unicast modes.

In one example, the extensible framing structure includes an extensible OFDM framing structure.

In one example, the extensibility tool includes at least one of base band sample rates and time-aligned symbols.

In one example, the combining a centralized radio access network topology with an intelligent IP core network enables multi radio access technologies.

In one example, a first radio access technology is dynamically assigned to at least one cell sector on a tall tower under intelligence of a node in IP core network, and a second radio access technology is assigned for tall towers and larger service areas.

In one example, the multi radio access technologies are enabled using a bootstrap.

In one example, the method further includes the step of gathering user data at the intelligent IP core network and enabling personalized services through paging based on the gathered user data.

In one example, the personalized services are further enabled based on geographical awareness or geographical location.

In one example, the method further includes the step of providing a hyper local service based on geographical awareness via functionality enabled by the intelligent heterogeneous network.

In one example, the method further includes the step of providing enhanced life-line emergency services via functionality enabled by the intelligent heterogeneous network.

In one example, the extensible framing structure is configured to encapsulate a third party symbol for transport and efficient use of spectrum resources.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example intelligent heterogeneous network.

FIG. 2 illustrates an example centralized C-RAN IP Core (NFV/SDN) network architecture.

FIG. 3 illustrates example enabling time align frames.

FIG. 4 illustrates an example general physical layer frame and bootstrap structure.

FIG. 5 illustrates an example LTE Type 2 Frame (TDD).

FIG. 6 illustrates an example uplink/downlink configuration.

FIG. 7 illustrates an example uplink/downlink configuration.

FIG. 8 illustrates a flow chart of the synchronization and signaling procedures used for LTE eMBMS.

FIG. 9 illustrates an example time interleaving scheme.

FIG. 10 illustrates an example NGBP Framework including C-RAN and digital BBU processing and Time Interleaving in NFV chain for small towers in a Heterogeneous network.

FIG. 11 illustrates another example NGBP Framework.

FIG. 12 illustrates an example Network using paging in LTE-A.

FIG. 13 illustrates an example NGBP Intelligent Heterogeneous network.

FIG. 14 illustrates an example NGBP Intelligent Heterogeneous network.

### DETAILED DESCRIPTION

### Introduction

A new concept of OFDM Radio Frame Extensibility supporting a Broadcast/Unicast (TDD) mode via an intelligent heterogeneous wireless network is introduced herein. To augment future broadcast business models to remain competitive and to serve their local communities in the internet age after the FCC incentive auction scheduled for 2016 is implemented is the spirit of this disclosure. It should be appreciated that the examples described herein assume a broadcaster-centric view of the future but re-thinking the business model in an era of 5G deployment is not to be precluded and will not deviate from the spirit of this disclosure.

The following abbreviations may be used throughout this description and should be understood accordingly:

### LIST OF ACRONYMS & ABBREVIATIONS

ATSC Advanced Television Systems Committee

BSR Baseband Sampling Rate

C-RAN Centralized or Cloud Radio Access Network

eMBMS Evolved Multimedia Broadcast Multicast Service

FDD Frequency Division Duplex

FFT Fast Fourier Transform

GI Guard Interval

MME Mobile Management Entity

MNO Mobile Network Operator

NGBP Next Generation Broadcast Platform

OFDM Orthogonal Frequency Division Multiplexing

RAN Radio Access Network

RAT Radio Access Technology

SDI Software Defined Infrastructure

SDN Software Defined Network

SDR Software Defined Radio

TDD Time Division Duplex

NFV Network Function Virtualization

It should be further appreciated that the extensible Next Gen Broadcast Platform (“NGBP”) that will be described in the following examples is outside the scope of ATSC and no endorsement should be assumed. Rather, an intelligent heterogeneous wireless broadcast network in the future is the vision.

Forward looking reference of broadcast-like use cases is pondered to help set context and a reference to NGMN Alliance 5G White Paper (February 2015) is made. By referencing NGMN 5G white paper's Broadcast-Like use cases for 5G, the necessity of a return channel (fulfillment of these broadcast-like use cases) is notable. This becomes the motivation for enabling a return channel using TDD and alignment with a LTE Type 2 Frame (TDD) structure as an example of the concept. LTE-A has a Unicast/Broadcast TDD mode termed eMBMS and this will be used as a known reference for a next generation broadcast platform heterogeneous network envisioned. It should be understood the LTE-A Type 2 Frame (TDD) is only a convenient OFDM Frame structure for demonstrating the concept but isn't required.

It is contemplated that in future 5G network architectures, a unified TDD/FDD frame structure may emerge and the distinction between TDD and FDD may be blurred, or completely removed, facilitating a unified but flexible duplex mechanism. The benefits of TDD mode (return channel and its attributes) will be discussed with respect to NGBP.

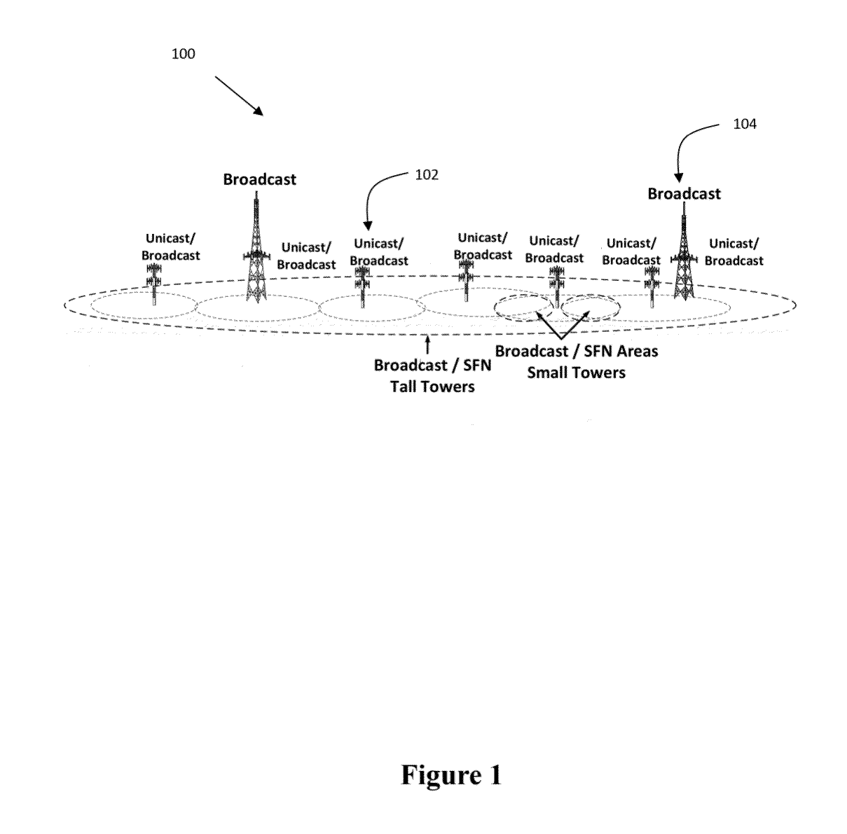

FIG. 1 illustrates an example intelligent heterogeneous network 100. In particular, hyper local services 102, such as personal and geo-fenced for example, are communicated via an intelligent heterogeneous network using Time Division Duplex (TDD) mode blended synergistically into a tall tower broadcast service 104. To set proper context, it should be understood that the FCC has encouraged broadcasters in the USA to share spectrum as an option to clear spectrum for the FCC incentive auction. FIG. 1 is an example of one concept of sharing broadcast spectrum resources post-auction using new technical blocks and flexible broadcast architecture. This one example should be understood not to limit its scope for provisioning of resources in time, frequency, and space domains.

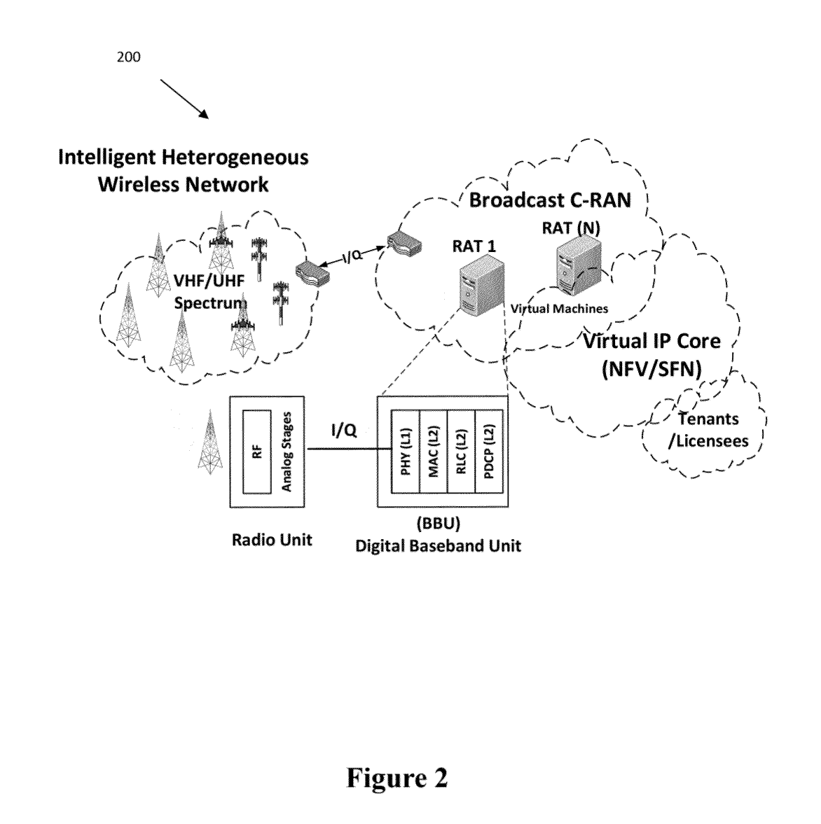

The focus herein shall be on using extensible tools, to be described, to design a NGBP Frame using LTE-A Frame Type 2 as a proxy. It is assumed, and therefore not discussed, that the scheduling of uplink/downlink unicast and broadcast resources are dynamically assigned using centralized C-RAN IP Core (NFV/SDN) network architecture 200 as conceptually illustrated in FIG. 2.

Extensibility Tools

Three extensibility tools are introduced herein and described with different sets of constraints and parametrization than those selected in ATSC 3.0. The extensibility tools include: Baseband Sampling Rates, Time Aligned Symbols/Frames, and Bootstrap tool.

Baseband Sampling Rates

The first step towards establishing a flexible and extensible IP platform begins by designing Baseband Sampling Rates (BSR) that can easily correlate with LTE, and hence future 5G, and be synergistic for the future with a focus toward mobile and TV-Everywhere type services. ATSC 3.0 is non-backward compatible and offers broadcasters extensibility for the future, though the initial version of ATSC 3.0 set certain constraints. NGBP looks past ATSC 3.0 while using these tools, in part, for extensibility.

For example, the following equation was adopted in ATSC 3.0 but was constrained in that only 6, 7, and 8 MHz bandwidth sampling was defined for traditional TV.

ATSC 3.0=(N+16)×0.384 MHz: (N) has range (0-127) N was constrained to 3 values for (6,7,8) MHz bandwidths equ. (1)

The NGBP, however, does not have the same constraint and is, therefore, extensible, as illustrated in the following equation:

NGBP=(N+16)×0.384 MHz: (N) has full range (0-127) and is not constrained equ. (2)

LTE Sampling Rate=0.384 MHz×(N) equ. (3)

Where Sampling factor (N) is Function of channel Bandwidth in LTE:
1.4 MHz (N=5)
3 MHz (N=10)
5 MHz (N=20)
10 MHz (N=40)
15 MHz (N=60)
20 MHz (N=80)

Thus, NGBP sampling rate is extensible and can replicate LTE common bandwidths today, as well as provide more granularity in the future. One example of using an LTE Type 2 Frame as Proxy with 10 Mhz (N=40) will be used herein, although it should be appreciated that any value N (0-127) may be used.

Time Aligned Symbols/Frames

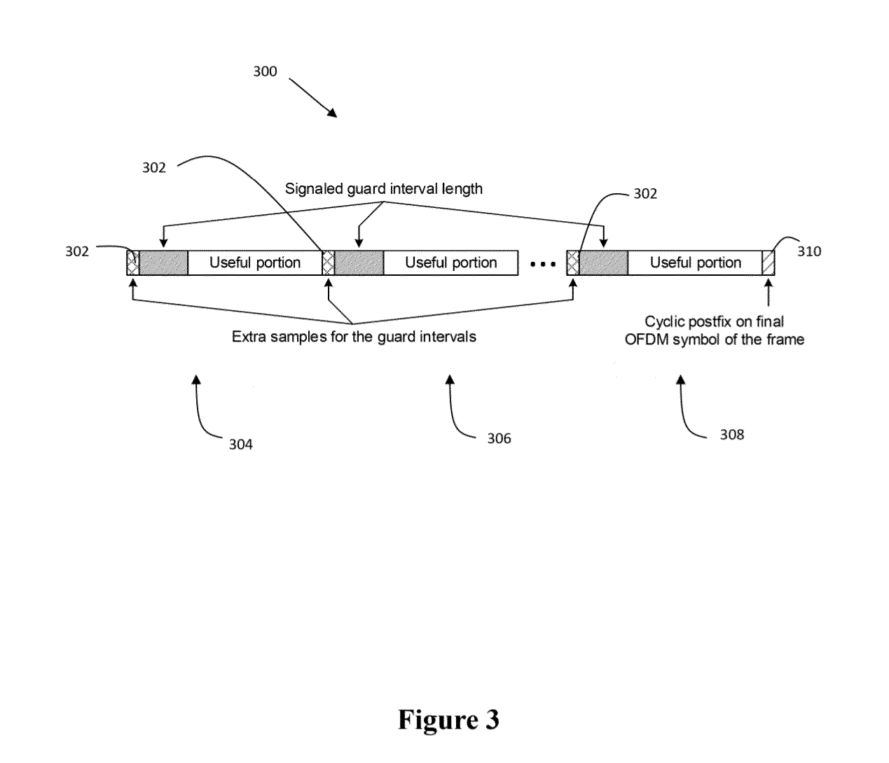

The LTE Frame is exactly 10 ms in duration and composed of 10 sub-frames, each 1 ms. Using the NGBP concept of excess sample distribution, alignment to 1 ms can be achieved with broadcast symbols in converged frame. Time-aligned frames are achieved by determining the exact number of extra time (BSR) samples required to enable alignment to boundaries such as 10 ms. As illustrated in FIG. 3, these extra time samples 302 are distributed equally to the guard intervals of an OFDM symbol within the sub-frames 304, 306, and 308 of frame 300 and any final remaining excess samples to achieve exact time alignment are used to create a cyclic postfix 310 on the final OFDM symbol in the final sub-frame 308.

Bootstrap Tool

Broadcasters anticipate providing multiple wireless-based services, in addition to just broadcast television in the future. Such services may be time-multiplexed together within a single RF channel. As a result, there exists a need to indicate, at a low level, the type or form of a signal that is being transmitted during a particular time period, so that a receiver can discover and identify the signal, which in turn indicates how to receive the services that are available via that signal.

To enable such discovery, a bootstrap signal can be used. This comparatively short signal precedes, in time, a longer transmitted signal that carries some form of data. New signal types, at least some of which have likely not yet even been conceived, could also be provided by a broadcaster and identified within a transmitted waveform through the use of a bootstrap signal associated with each particular time-multiplexed signal. It should be appreciated that some future signal types indicated by a particular bootstrap signal may even be outside the scope of the ATSC. Thus, the bootstrap provides a universal entry point into a digital transmission signal. It employs a fixed configuration (e.g., sampling rate, signal bandwidth, subcarrier spacing, time domain structure) known to all receiver devices.

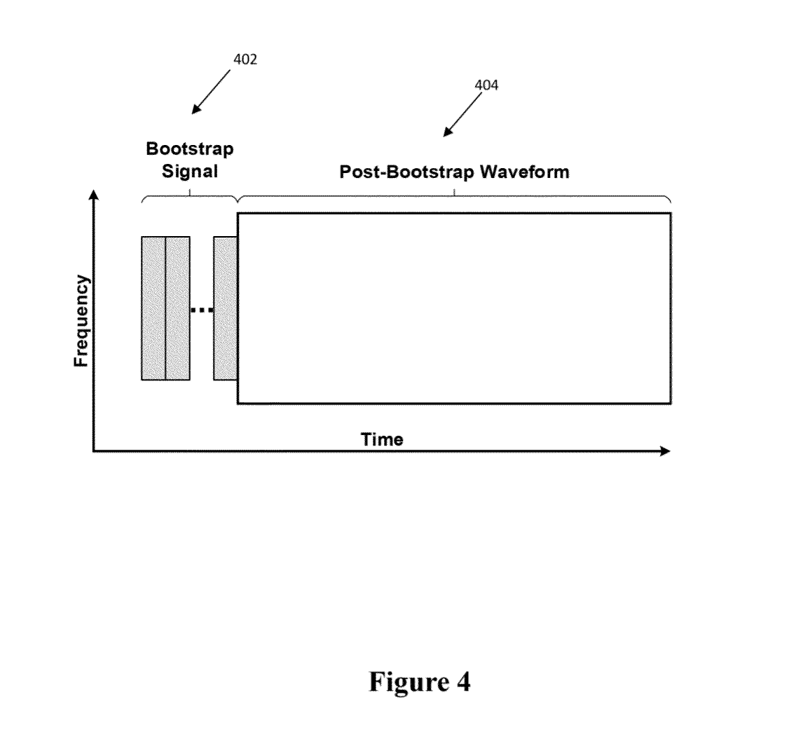

FIG. 4 illustrates an overview of the general structure of the bootstrap signal 402, and the bootstrap position relative to the post-bootstrap waveform 404 (i.e., the remainder of the frame). The bootstrap 402 consists of a number of symbols, beginning with a synchronization symbol positioned at the start of each frame period to enable signal discovery, coarse synchronization, frequency offset estimation, and initial channel estimation. The remainder of the bootstrap contains the necessary signaling to permit the reception and decoding of the remainder of the frame to begin.

In one example, the bootstrap uses a fixed sampling rate of 6.144 Msamples/second and a fixed bandwidth of 4.5 MHz, regardless of the channel bandwidth used for the remainder of the frame. The time length of each sample of the bootstrap is fixed by the sampling rate.

f_{S}=6.144 Ms/sec equ. (4)

f_{S}=0.384 MHz×(N+16) [N=0] equ. (5)

T_{S}=1/f_{S} equ. (6)

BW_{Bootstrap}=4.5 MHz equ. (7)

An FFT size of 2048 results in a subcarrier spacing of 3 kHz.

N_{FFT}=2048 equ. (8)

f_{Δ}=f_{S}/N_{FFT}=3 kHz equ. (9)

In one example, each bootstrap symbol shall have time duration of 500 us.

The bootstrap design extensibility via the following core concept is of particular interest. The bootstrap version is expressed in text as a major version number (decimal digit) followed by a period and a minor version number (decimal digit), e.g., bootstrap version 0.0. The major version and minor version are referenced in code as bootstrap_major_version and bootstrap_minor_version, respectively. A Zadoff-Chu (ZC) root and a pseudo-noise (PN) sequence seed are used for generating the base encoding sequence for bootstrap symbol contents. A major version number (corresponding to a particular signal type) is signaled via selection of the ZC root. A minor version (within a particular major version) is signaled via appropriate selection of the PN sequence seed. It should be appreciated that the bootstrap isn't needed to create an example of Type 2 Frame (TDD) but will be used in enabling Multi-RAT Heterogeneous Network Topology as illustrated in FIG. 1.

Introduction of the 3GPP LTE Type 2 frame (TDD)

The LTE air-interface supports two frame structures both 10 ms in duration using parameters in Table 1 as a function of spectrum bandwidth: frame structure type 1 (FDD) is applicable to both full duplex and half duplex and frame structure type 2 is only applicable to (TDD).

TABLE 1
LTE Frame Parameters Example

| Spectrum allocation | 1.4 MHz | 3 MHz | 5 MHz | 10 MHz | 15 MHz | 20 MHz |
|---|---|---|---|---|---|---|
| Sub-frame duration | 1 ms | | | | | |
| (TTI) | | | | | | |
| Frame Duration | 10 sub-frames = 10 ms | | | | | |
| Subcarrier spacing | 15 kHz | | | | | |
| Sampling Frequency | 1.92 MHz | 3.84 MHz | 7.68 MHz | 15.36 MHz | 23.04 MHz | 30.72 MHz |
| FFT size | 128 | 256 | 512 | 1024 | 1536 | 2048 |

| | |
|---|---|
| Number of OFDM | 12 symbols/16.67us (CP) Extended Cyclic Prefix |
| symbols per sub- | |
| frame/CP | |
| Physical Resource | 180 kHz = 12 subcarriers |
| Block | |

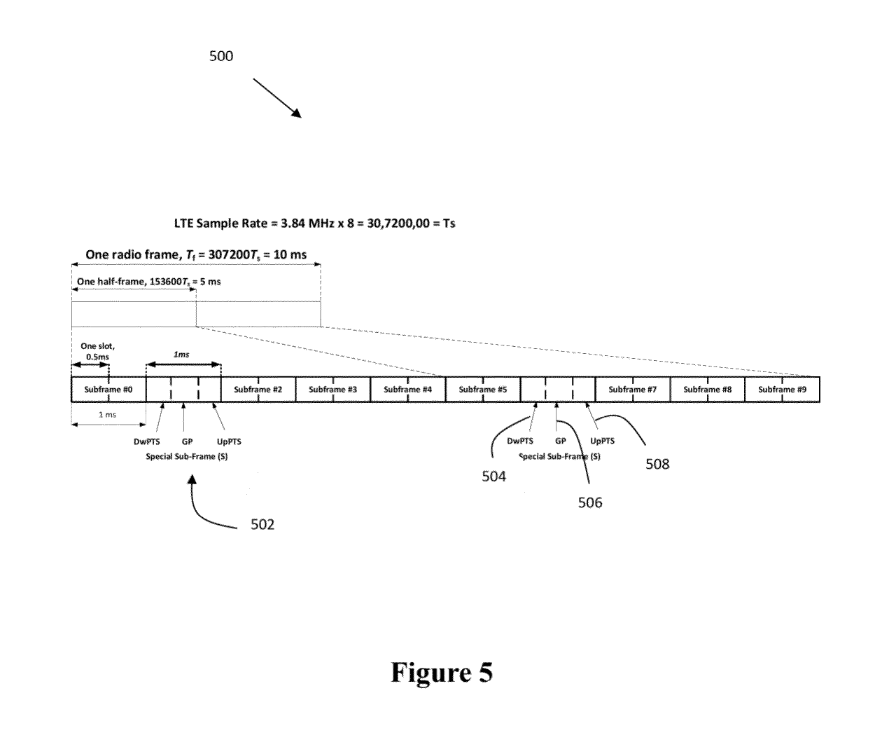

FIG. 5 illustrates an example LTE Type 2 Frame (TDD) 500. The frame 500 includes special sub-frames or switchpoints 502. The special sub-frames 502 include a download pilot time slot 504 and an uplink pilot time slot 508, which allows switching between Downlink and Uplink, and a guard period 506, which allows for network timing adjustments.

Table 2 shows the Up-link/Down-link configurations possible in LTE Frame Type 2.

TABLE 2
Uplink/Downlink Configurations LTE Frame Type 2

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Sub-frame number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

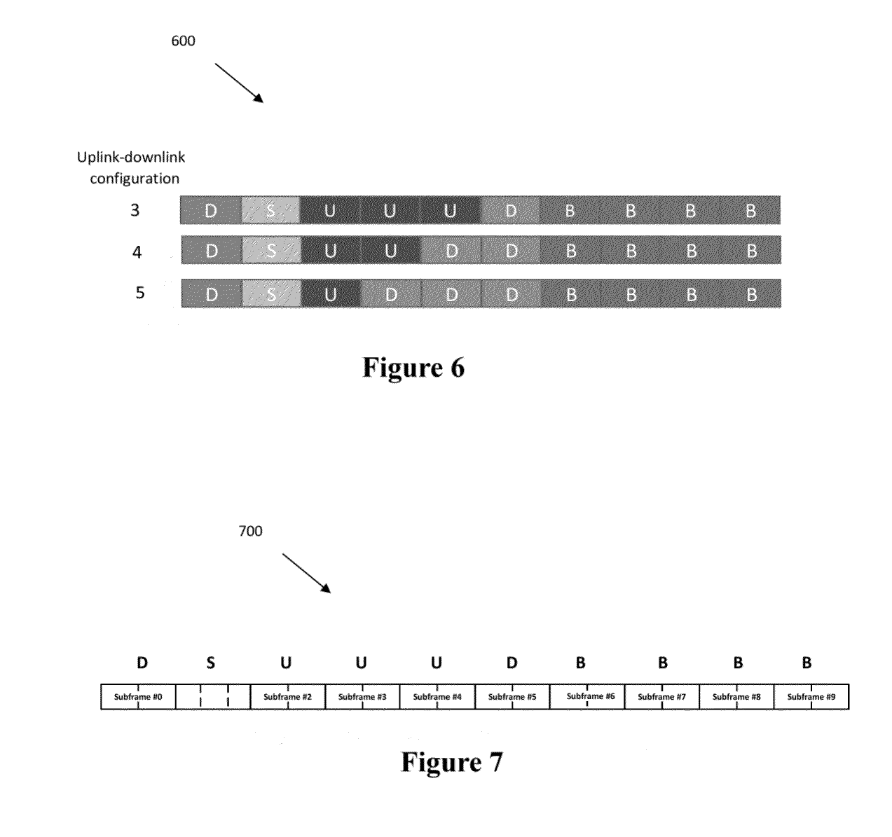

Frame Type 2 Configurations 3, 4, 5, as shown in Table 2, are only of interest for this example and will be the focus. The sub-frames are numbered 0-9, each 1 ms. Sub-frames 0 and 5 are always reserved for Downlink, or Unicast, and they have important synchronization (PSS/SSS) and signaling (BCH). The other remaining (D) can be shared with (B) NGBP broadcast. So a mix of D, U, B can be assigned over a series of 10 ms frames to meet service requirements in the example. FIG. 6 illustrates an example uplink/downlink configuration 500 as illustrated in Table 2.

It should be appreciated that although the example LTE Type 2 Frame 500 shows a switch point 502 once every 5 ms, an example LTE Type 2 Frame can be configured to include a switch point at different intervals, for example, every 10 ms.

FIG. 7 illustrates an example using Type 2 Frame TDD configuration 3 700 of FIG. 6. It should be appreciated that although Uplink/Downlink configuration 3 will be used in an examples described herein, this is just one of many possible examples within the constraints of LTE-A and this may evolve when 5G deployment emerges.

Table 3 includes the assumed parameters for Uplink (U) and Downlink (D) while Table 4 is includes the assumed parameters for Broadcast (B), although it should be appreciated that other suitable parameters may be used.

TABLE 3
LTE (U) (D) Symbols Example

| Spectrum allocation | 10 | MHz |
|---|---|---|
| Sub-frame duration (TTI) | 1 | ms |
| Frame Duration | 10 sub-frames = 10 ms | |
| Subcarrier spacing | 15 | kHz |
| Sampling Frequency | 15.36 | MHz (N = 40) |
| .384 MHZ × (N) | | |

| | |
|---|---|
| Sample rate (Ts) | 1/15,360,000 |
| FFT size | 1024 |
| Number OFDM symbols | 12 |
| sub-frame (TTI) | |
| Samples/Symbol | 1024 |
| Useful Symbol (TU) us | 66.667 |
| (CP)us | 16.66 |
| | Extended Cyclic Prefix |
| Samples/CP | 256 |
| Doppler (MPH) @ 600 MHz | 1678 |

TABLE 4
Broadcast Symbols (B) Example

| Spectrum allocation | 10 | MHz |
|---|---|---|
| Sub-frame duration (TTI) | 1 | ms |
| Frame Duration | 10 sub-frames = 10 ms | |
| Subcarrier spacing | 1.031 | kHz |
| Sampling Frequency | 16.896 | MHz (N = 44) |
| .384 MHZ × (N) | | |

| | |
|---|---|
| Sample rate (Ts) | 1/16,896,000 |
| FFT size | 16K |
| Number OFDM symbols | 1 |
| sub-frame (TTI) | |
| Samples/Symbol | 16384 |
| Useful Symbol (TU) us | 969.69 |
| (CP) us | 30.3 |
| Samples/CP | 512 |
| Doppler (MPH) @ 600 MHz | 115 |

It should be appreciated that, since only one useful symbol/sub-frame was selected in the example, use of extra samples to achieve time alignment isn't required but would be required with other examples including multi-symbols per sub-frame of the many selections possible. Extra samples are then added as shown in FIG. 3 to sum all symbols to exactly 1 ms.

In order to successfully embed (B) broadcast symbol in eMBMS, the LTE PSS (Primary Synchronization Signal) and SSS (Secondary Synchronization Signal) are retained as is the low level signaling because they enable time and frequency synchronizations, and indicate the identity of the cell and the CP length, etc. with the needed low level signaling in this LTE Type 2 Frame example as a proxy.

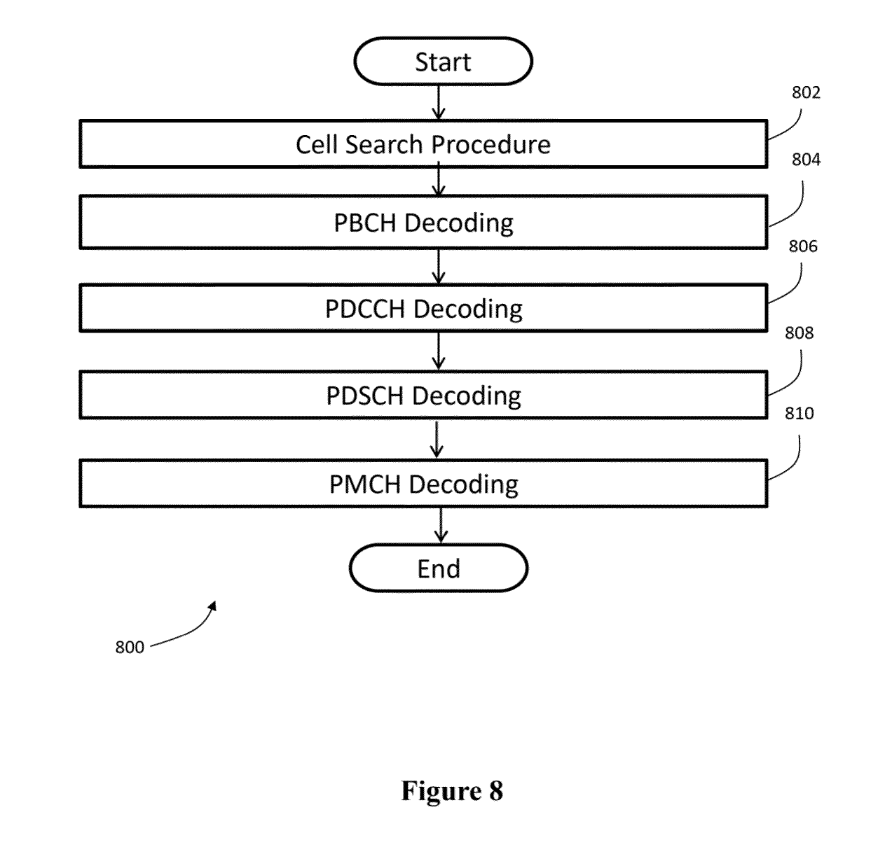

FIG. 8 illustrates a flow chart of the synchronization and signaling procedures used for LTE eMBMS. Step 802 includes a cell search procedure. The cell search procedure 802 includes PSS detection, including slot timing detection. The cell search procedure 802 also includes SSS detection, including frame timing detection, cell identification, and CP length. Step 804 includes PBCH decoding, or MIB. Step 806 includes PDCCH decoding, including schedule of PDSCH transmission for UE or for SI messages. Step 808 includes PDSCH decoding for non MBMS sub-frames. PDSCH decoding includes SIB1, or schedule of other SIBs, SIB2, or MBMS sub-frames patter, and SIB3, or MBMS control information. Step 810 includes PMCH decoding for MBMS sub-frames.

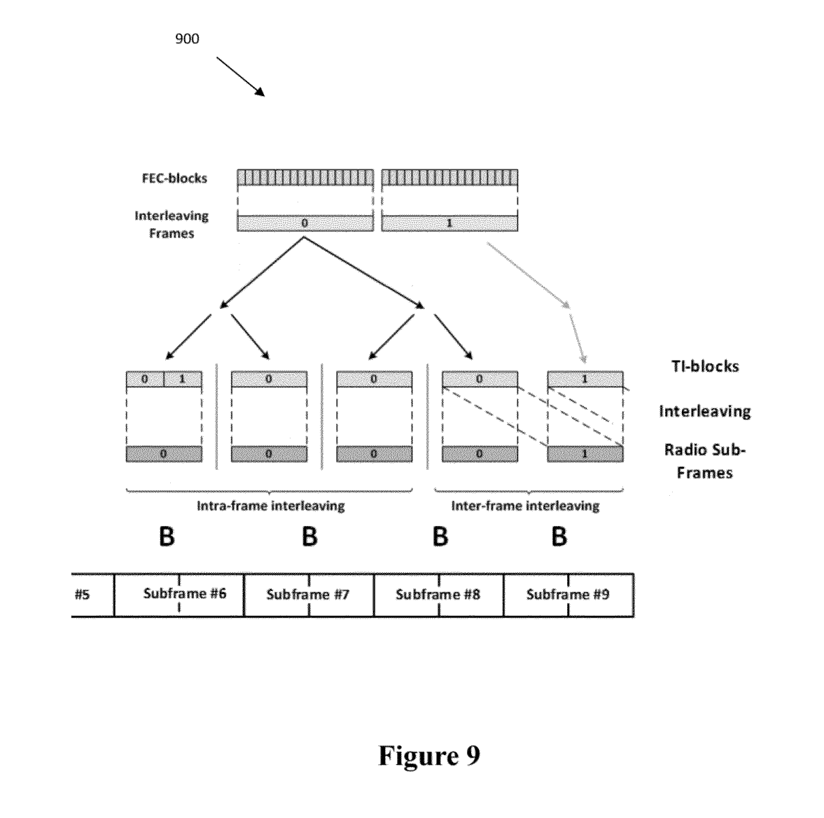

In one example, it may be desirable to increase fading robustness because broadcast symbols are constrained in LTE-A (eMBMS) with a maximum interleaving depth of only 1 ms. In the example for NGBP (B) sub-frames 6, 7, 8, and 9, a new upper layer is used from NGBP with a robust time interleaving scheme 900 as shown conceptually in FIG. 9 to improve time diversity and broadcast performance in the NGBP design, and therefore eliminate the constraint on latency. All other sub-frames are processed as in normal 3GPP LTE-A (eMBMS), not shown, and fundamental weakness is whole system all sub-frames (U, D, B) constrained by latency (1 ms) being optimized for unicast.

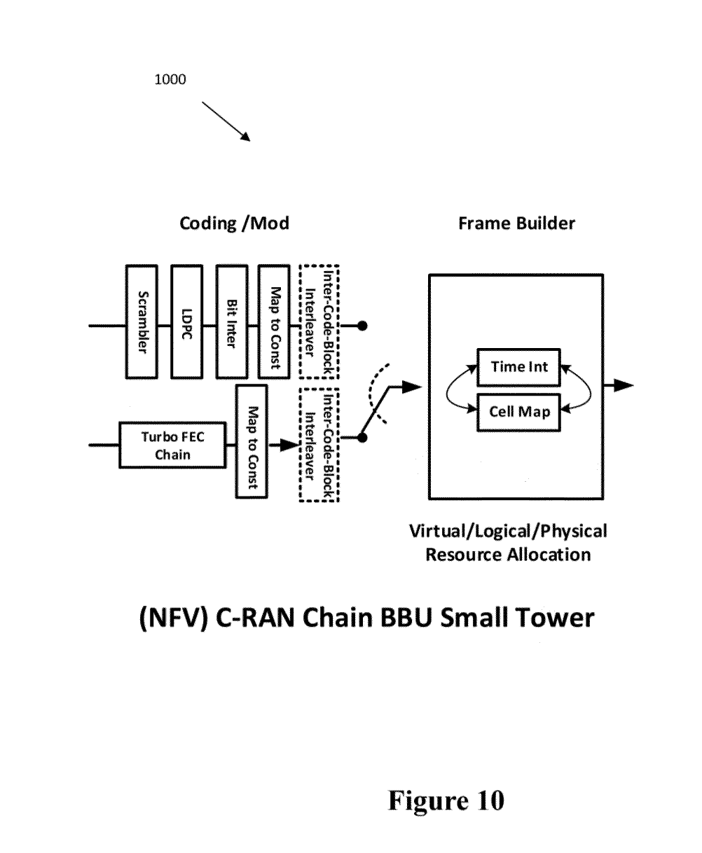

FIG. 10 illustrates an example NGBP Framework 1000 including C-RAN and digital BBU processing and Time Interleaving in NFV chain for small towers in a Heterogeneous network. It should be appreciated that using C-RAN with (BBU) in Cloud and Analog Unit (AU) at each transmission site enables multiple waveforms (Multi-RAT) capability for Heterogeneous Network and this extensibility is supported by A/321 bootstrap.

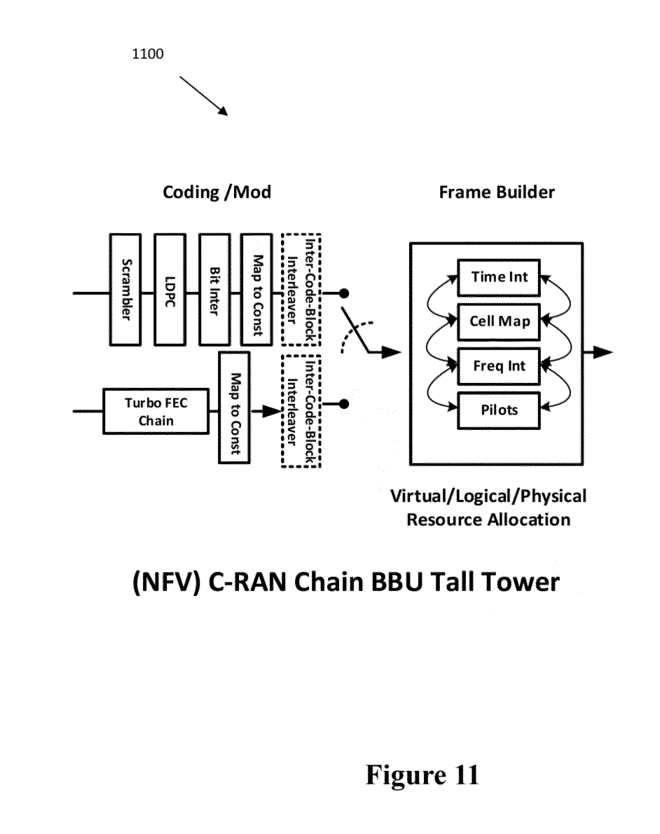

The NGBP Framework 1000 illustrated in FIG. 10 enables selection of FEC Type/Interleaving and Turbo Code is shown selected in NFV Chain for this example. There is no constraint here to LTE-A eMBMS. The NGBP Framework 1100 shown in FIG. 11, on the other hand, enables selection of FEC Type LDPC/Turbo of NFV Chains and interleaving etc. for a specific RAT parameterization selected to be optimal for the Tall Towers with broadcast only antennas in SFN.

Paging

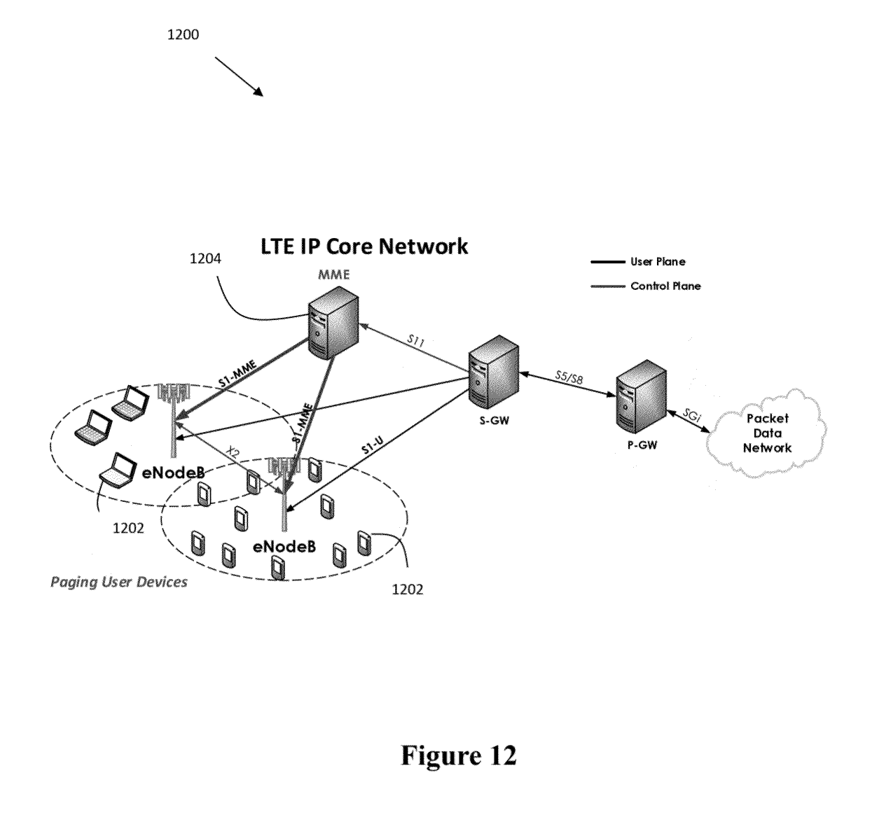

LTE Paging/Location Area Updates enable personalization and geo-targeting in Hyper Local service in NGBP. This enables more value to a broadcaster, in addition to just returning data via a return channel to Intelligent IP Core in hyper local services and other use cases. Intelligent IP Core construct is new to the future of broadcast architectures. This enables much richer meta data collection on consumers (IP Core) than possible on public Wi-Fi and can enable broadcast-like use cases. FIG. 12 illustrates an example Network 1200 using paging in LTE-A.

Paging is used primarily to notify user equipment 1202 in idle state about incoming data connections: call, text, etc. A Paging Control Channel (PCCH) is used in LTE for paging of terminals whose location on a cell level is not known to the IP Core network. The Paging Channel (PCH) is used for transmission of paging information and supports discontinuous reception (DRX) to allow the terminal to save battery power by waking up to receive the PCH only at predefined time instants defined by operator. Also, in an example of NGBP, a paging message can be used for terminals in RRC_CONNECTED modes to enhance services under programmed broadcaster control C-RAN IP Core.

In LTE paging, a message originates from the MME entity or IP core 1204 to notify the terminal 1202 about incoming connection requests. The indication of a system-information update is another use of the paging mechanism, as is alerts or public warning systems. This could form genesis for an enhanced Emergency Alert Service (EAS) for NGBP that could be geo-targeted to the public in an intelligent heterogeneous networks in the future after the FCC Incentive auction gets implemented.

Using paging on the schedule controlled by a broadcaster, the location of a customer resides in IP Core database along with other data specific to a registered user and can be helpful in future use cases that aren't traditional broadcast use cases.

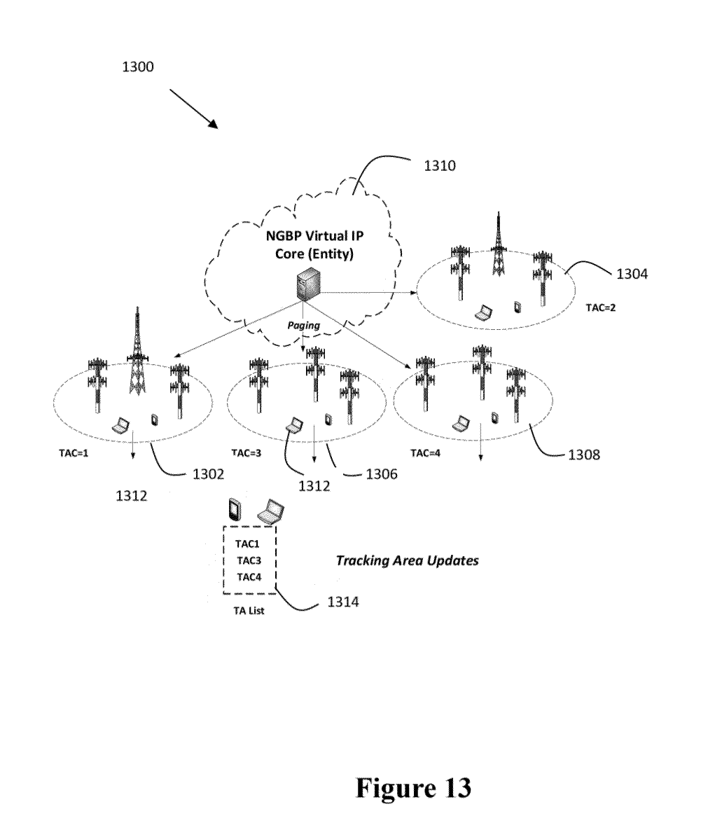

When data is to be sent from the IP core 1204 to a terminal 1202 in idle mode, the network 1204 must send a “wake up” to the terminal 1202 in advance to be prepared to receive the data or EAS Message, etc. FIG. 13 is one embodiment of a future NGBP Intelligent Heterogeneous network 1300. In this embodiment, the data terminal 1312 is located in Tracking area 3 1306. It should be appreciated that Tracking Areas 1302, 1304, 1306, and 1308 are planned by broadcasters. Next, the entity in NGBP IP Core network 1310, which is responsible for paging, considers that the Terminal 1312 is located in, say, TA3 1306. When the network 1300 sends a wake-up signal to signify data is on the way, it sends a paging message to terminal 1312 in TA3 1306 via IP Core entity 1310 shown. A terminal 1312 in idle state wakes up at certain periods, which may be defined by Broadcasters, in one example, to check for a paging message to see if there is any incoming data. If the terminal 1312 finds it has been paged by network 1310, it turns back to active state to receive the data. Otherwise, the terminal 1312 conserves battery in idle mode.

As illustrated in FIG. 13, the NGBP network 1310 has to have updated location information about terminals 1312 in idle state to find out in which TA 1302, 1304, 1306, and 1308 a particular terminal 1312 is located. For this, the protocol is for the terminal 1312 to notify the NGBP network 1310 of its current location by sending a TAU message every time it moves between defined Tracking Areas 1302, 1304, 1306, and 1308. The terminal 1312 also maintains an active Tracking Area List 1314.

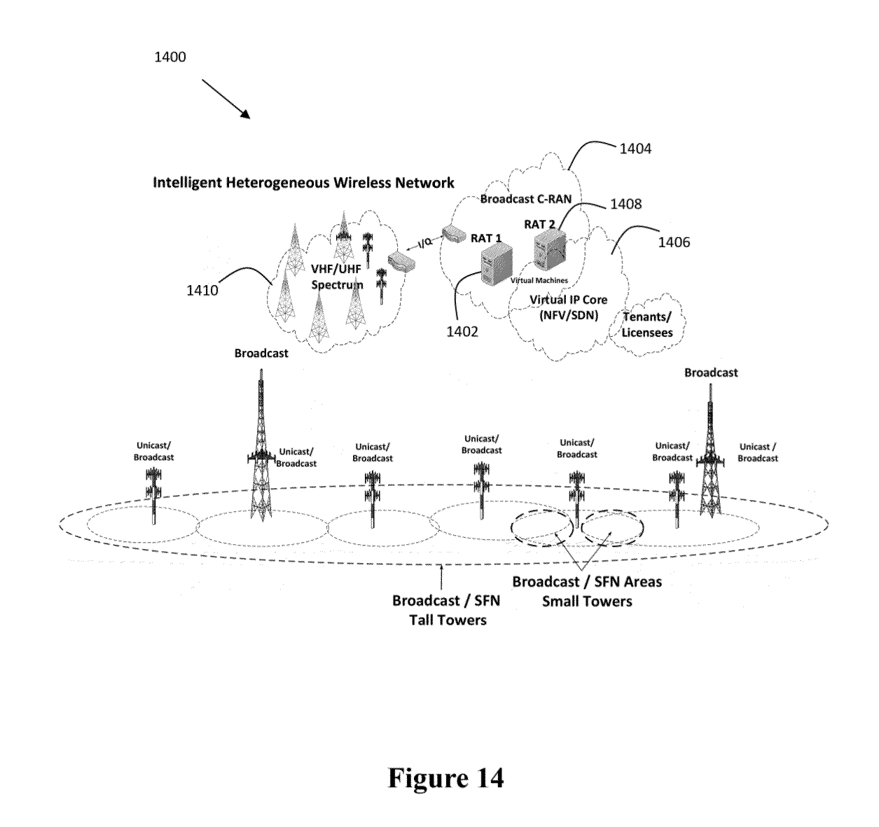

FIG. 14 illustrates an Intelligent Heterogeneous Wireless Network (NFV/SDN) 1400 for future terrestrial broadcast topologies. The network 1400 is designed for “Service” and not just “Coverage” because the business models are changing and the supporting network technology has evolved. Moreover, regulatory pressure in the USA demands better uses of broadcast spectrum, as evidenced by the FCC incentive auction 2016, one such effort to align the use of broadcast spectrum with 21^{st} century consumer demands for video and broadband services. In the future, the blending of terrestrial off-air and Internet-delivered video and media leveraging both wireless and wireline (heterogeneous) networks is the vision of NGBP. In the future, TV service everywhere to include “hyperlocal” to enhance news and other programming and will also to create opportunity to sell ads, including local targeting down to a neighborhood level is one such goal for a broadcast platform (NGBP). If a viewer decided to provide a personal profile, for example, and this is known in the IP Core network, then special offers could be directed to him or her directly to match personal preferences supported by ads while still striving to preserve privacy. This will be economical to consumers and offer alternatives in the market, while continuing to provide the public life-line services in times of emergencies and enhanced benefits of a new broadcast IP platform that can interwork may be seen in the public interest.

The exemplary heterogeneous network 1400 is envisioned using the extensible tools discussed and supports multiple waveforms or Radio Access Technologies (RAT) signaled by the bootstrap. The first, RAT 1 1402 shown in C-RAN 1404 is the exemplary LTE-A Type 2 frame (TDD) and can be dynamically assigned to small towers or cell sectors on the tall towers under intelligence of nodes in IP Core network 1406. The second, RAT 2 1408 (Broadcast Only) is for tall towers and larger service areas. It should be appreciated that this is a service centric holistic re-think involving shared infrastructure for cost savings and spectrum efficiency and could enable business models that can make it economic and attractive for the needed investment in the future or partnerships, and so on.

The VHF/UHF broadcast spectrum 1410 can be shared among broadcasters and other licensees and tenants. Since the VHF/UHF spectrum 1410 isn't fungible, the pooling or sharing of these resources in a market driven manner under C-RAN/NFV/SDN IP Core can help the market find the best mix or use of spectrum driven by application to preserve a robust broadcast TV industry when software is centric to communications infrastructures.

To improve the reliability of broadcast services, the proven OFDM concept of Single Frequency Network (SFN), the axiom of which is producing Coherent Symbols is scheduled from C-RAN/NFV/SDN IP Core. Thus, in the large service areas of tall towers and in portions of small tower service areas, tight centralized synchronization of sites/sectors using tight timing of adjacent small towers or sectors with overlapping coverage is achieved. This could be in highly population dense city center areas at certain times of day or at stadiums and other venues, for example.

In particular, the Intelligent Wireless Heterogeneous Network can mitigate shortcomings of existing contemplated networks using a feedback channel (uplink) for interactive services or acknowledgement of information. For example, the several broadcast-like use cases that may be proposed for future 5G networks discussed earlier may be addressed by the Intelligent Wireless Heterogeneous Network as follows:

News and Information—With all the physical resources (Multi-RAT) of the Intelligent Heterogeneous Wireless Network abstracted and under centralized NFV/SDN software control and orchestration, using in part the extensible tools described herein can enable a broadcast optimized network with supplemental unicast added to deliver the TV Everywhere experience and appropriate news and information regardless of the device and in specific geographic areas.

Local Broadcast-Like Services—With the Intelligent Heterogeneous Wireless Network, hyperlocal or local services targeting specific geographic areas for entertainment or life-line emergency services would be possible.

Regional Broadcast-Like Services—With the Intelligent Heterogeneous Wireless Network, similar services with a broadcast optimized network with supplemental unicast would be possible.

National Broadcast-Like Services—The robust wide area broadcast SFN coupled with supplemental unicast would enable successful updates to be confirmed and documented. This may become compelling to vertical industries during certain times of day when entertainment isn't a driver of network.

Any of the various embodiments described herein may be realized in any of several various forms, e.g., as a computer-implemented method, as a computer-readable memory medium, as a computer system, etc. A system may be realized by one or more custom-designed hardware devices such as Application Specific Integrated Circuits (ASICs), by one or more programmable hardware elements such as Field Programmable Gate Arrays (FPGAs), by one or more processors executing stored program instructions, or by any combination of the foregoing.

In some embodiments, a non-transitory computer-readable memory medium may be configured so that it stores program instructions and/or data, where the program instructions, if executed by a computer system, cause the computer system to perform a method, e.g., any of the method embodiments described herein, or any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or any combination of such subsets). The computer system may be realized in any of several various forms. For example, the computer system may be a personal computer (in any of its various realizations), a workstation, a computer on a card, an application-specific computer in a box, a server computer, a client computer, a hand-held device, a mobile device, a wearable computer, a sensing device, a television, a video acquisition device, a computer embedded in a living organism, etc. The computer system may include one or more display devices. Any of the various computational results disclosed herein may be displayed via a display device or otherwise presented as output via a user interface device.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the Applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed:

1. A method for operating an extensible mode of communication in an intelligent heterogeneous network, the method comprising the steps of:
using an extensibility tool to provide an extensible framing structure;
combining a centralized radio access network topology with an intelligent IP core network to enable sharing of spectrum resources; and
providing a supplemental return channel to facilitate paging.

2. The method of claim 1, wherein the extensible mode of communication comprises time-division duplexing, including broadcast and unicast modes.

3. The method of claim 1, wherein the extensible framing structure comprises an extensible OFDM framing structure.

4. The method of claim 1, wherein the extensibility tool is comprised of at least one of base band sample rates and time-aligned symbols.

5. The method of claim 1, wherein the combining a centralized radio access network topology with an intelligent IP core network enables multi radio access technologies.

6. The method of claim 1, wherein a first radio access technology is dynamically assigned to at least one cell sector on a tall tower under intelligence of a node in IP core network, and wherein a second radio access technology is assigned for tall towers and larger service areas.

7. The method of claim 5, wherein the multi radio access technologies are enabled using a bootstrap tool.

8. The method of claim 1, further comprising the step of gathering user data at the intelligent IP core network and enabling personalized services through paging based on the gathered user data.

9. The method of claim 8, wherein the personalized services are further enabled based on geographical awareness or geographical location.

10. The method of claim 1, further comprising the step of providing a hyper local service based on geographical awareness via functionality enabled by the intelligent heterogeneous network.

11. The method of claim 1, further comprising the step of providing enhanced life-line emergency services via functionality enabled by the intelligent heterogeneous network.

12. The method of claim 1, wherein the extensible framing structure is configured to encapsulate a third party symbol for transport and efficient use of spectrum resources.
